(19) United States
(12) Patent Application Publication
(10) Pub. No.: US 2017/0186103 A1
(43) Pub. Date: Jun. 29, 2017

(54) Gesture-aware friendship bands

(71) Applicants: Jose Elmer S. Lorenzo, Santa Clara, CA (US); Mary D. Smiley, Santa Clara, CA (US); Steven T. Holmes, Redwood City, CA (US); Lakshmanan Aruunachalam, Santa Clara, CA (US); Gary Y. Kwan, San Jose, CA (US)

(72) Inventors: Jose Elmer S. Lorenzo, Santa Clara, CA (US); Mary D. Smiley, Santa Clara, CA (US); Steven T. Holmes, Redwood City, CA (US); Lakshmanan Aruunachalam, Santa Clara, CA (US); Gary Y. Kwan, San Jose, CA (US)

(21) Appl. No.: 14/998,086

(22) Filed: Dec. 24, 2015

(51) Int. Cl. G06Q 50/00; G06Q 10/10; H04W 4/00; H04W 76/02; H04L 12/26; H04B 1/3827

(52) U.S. Cl. CPC G06Q 50/01; H04L 43/04; H04B 1/385; H04W 4/005; H04W 76/023; G06Q 10/10

(57) ABSTRACT

Systems and methods may identify local gesture data in a wearable device including a wrist-worn form factor and identify remote gesture data in a wireless transmission received by the wearable device. Additionally, a loyalty tracker may be incremented based on a correlation between the local gesture data and the remote gesture data. In one example, an attachment of an interchangeable component to the wearable device may be detected, wherein the loyalty tracker is incremented in response to the attachment.

### TECHNICAL FIELD

Embodiments generally relate to the use of wearable technology to form and/or reinforce interpersonal relationships. More particularly, embodiments relate to gesture-aware friendship bands.

### BACKGROUND

Interpersonal relationships are more frequently being formed online (e.g., via social networking sites). While convenient and easy, connections made solely online may be virtual in nature and lack the strength of face-to-face engagements.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a friendship band ecosystem according to an embodiment;

FIGS. 2A and 2B are side and top views, respectfully, of an example of a friendship band according to an embodiment;

FIG. 3 is an illustration of an example of a user interface according to an embodiment;

FIG. 4 is a flowchart of an example of a method of operating a peer-to-peer apparatus according to an embodiment;

FIG. 5 is a block diagram of an example of a peer-to-peer apparatus according to an embodiment; and

FIG. 6 is a block diagram of an example of a relationship facilitation architecture according to an embodiment.

### DESCRIPTION OF EMBODIMENTS

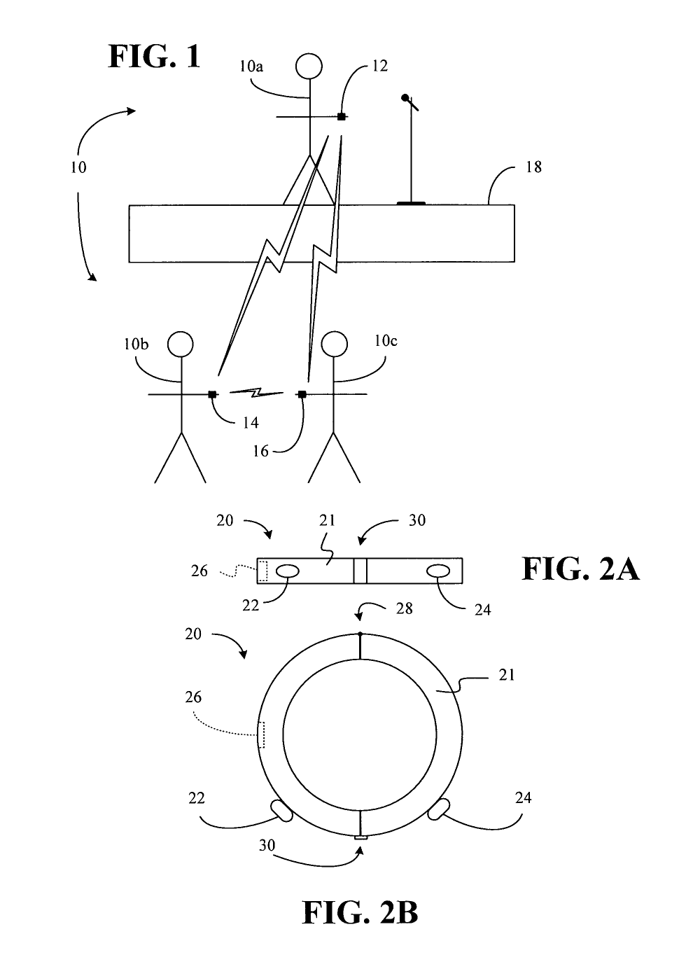

Turning now to FIG. 1, a friendship band ecosystem is shown in which a plurality of individuals 10 (10a-10c) form relationships, connections and/or friendships in conjunction with one or more face-to-face engagements. In the illustrated example, a first individual 10a wears a first friendship band 12 (e.g., a wearable device including a wrist-worn form factor such as, for example, a bracelet, watch and/or wrist band), a second individual 10b wears a second friendship band 14, and a third individual 10c wears a third friendship band 16. The face-to-face engagement may be a concert, fundraiser event, and so forth. For example, the first individual 10a might be a performer standing on a stage 18, wherein the second individual 10b and the third individual 10c are fans in attendance at the concert. As will be discussed in greater detail, the friendship bands 12, 14, 16 may enable the gesture-based identification, formation and tracking of friendship levels between the individuals 10.

Thus, one or more peer-to-peer wireless transmissions between the first friendship band 12 and the second friendship band 14 may enable the first friendship band 12 and the second friendship band 14 to monitor and/or document the frequent attendance of the second individual 10b at concerts given by the first individual 10a (e.g., tracking fan and/or loyalty status). Additionally, one or more wireless transmissions between the second friendship band 14 and the third friendship band 16 may enable the second friendship band 14 and the third friendship band 16 to monitor and/or document the shared loyalty that the second individual 10b and the third individual 10c may have to a brand, cause and/or identity associated with the first individual 10a. The second individual 10b and the third individual 10c may therefore form a stronger and more meaningful relationship based at least in part on their common presence at the same event. Moreover, the first individual 10a or organization associated with the first individual 10a may foster greater loyalty by encouraging individuals such as the second individual 10b and the third individual 10c to track their shared interests.

In one example, gestures and interchangeable components (e.g., detachable beads, crystals and/or gems) are used to identify and track the friendships and/or loyalties among the individuals 10. For example, the first individual 10a and the third individual 10c might perform a concurrent hand motion (e.g., a dance-related hand wave), wherein a wireless transmission from the first friendship band 12 to the third friendship band 16 may carry gesture data associated with the hand motion made by the first individual 10a. Upon receipt of the wireless transmission, the third friendship band 16 may determine whether there is a correlation between the two hand motions (e.g., the hand motions are substantially similar and/or follow a predetermined sequence). If so, the third friendship band 16 may automatically increment a loyalty tracker that documents the strength of the connection between the third individual 10c and a brand, cause and/or identity associated with the first individual 10a.

Similarly, the second individual 10b and the third individual 10c may perform a concurrent hand motion such as, for example, a handshake or high-five, followed by a tap between the second friendship band 14 and the third friendship band 16, wherein the tap triggers a wireless transmission of gesture data. In another example, the second individual 10b might make a throwing motion followed by the third individual 10c making a catching motion that triggers a wireless transmission of gesture data between the second friendship band 14 and the third friendship band 16. Accordingly, the second friendship band 14 and the third friendship band 16 may each receive the gesture data and use the gesture data to increment loyalty trackers of the friendship being formed between the second individual 10b and the third individual 10c. The friendship bands 12, 14, 16 may also automatically generate alerts (e.g., audible, visual, haptic) when nearby friends are detected.

With regard to the interchangeable components, detachable beads might be distributed at various events held by the first individual 10a so that the second individual 10b and the third individual 10c may collect the beads and attach them to the second friendship band 14 and the third friendship band 16, respectively (e.g., with each event having a different color). In such a case, the attachment of the interchangeable components may be automatically detected and used to further track the strength of the connection among the individuals 10. For example, if the second friendship band 14 contains several different colored beads, a loyalty tracker of the second friendship band 14 might be incremented to reflect a stronger connection between the first individual 10a and the second individual 10b (e.g., due to the attendance of multiple different concerts). Moreover, if the second friendship band 14 and the third friendship band 16 contain several of the same colored beads, loyalty trackers of the second friendship band 14 and the third friendship band 16 may be incremented to reflect a stronger connection between the second individual 10b and the third individual 10c (e.g., due to the attendance of the same concerts).

FIGS. 2A and 2B show side and top views, respectively, of a friendship band 20 having a housing 21 with a wrist-worn form factor. In the illustrated example, interchangeable components such as a first bead 22 and a second bead 24 are attached to the external housing of the friendship band 20. The friendship band 20 may also include a display 26 that visually presents the status of one or more loyalty trackers maintained on the friendship band 20. Additionally, the illustrated friendship band 20 includes a hinged portion 28 and a latch portion 30 to facilitate opening, closing and/or locking of the friendship band 20. Other physical configurations such as, for example, elastics, strings, etc., may also be used, depending on the circumstances. Moreover, although a wrist-work form factor is shown, other form factors may be used. Indeed, the friendship band 20 might alternatively have a form factor that enables it to be embedded in clothing or elsewhere on the body of the wearer.

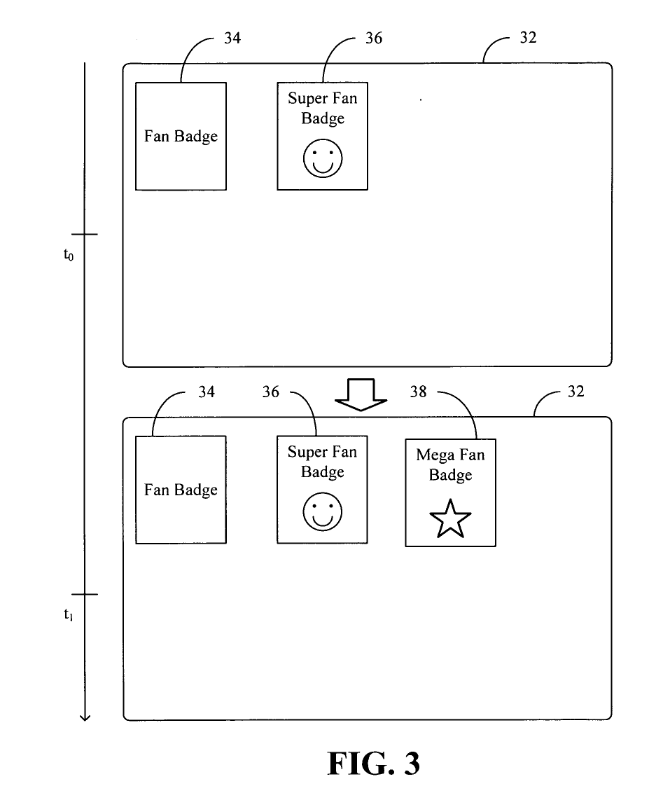

Turning now to FIG. 3, a user interface (UI) 32 is shown, wherein the UI 32 may be presented on a wearable device display such as, for example, the display 26 (FIG. 2), already discussed. In the illustrated example, at time to the UI 32 includes a first indicator 34 (e.g., “Fan Badge” graphical token/icon) and a second indicator 36 (e.g., “Super Fan Badge” graphical token/icon). At time ti, a correlation may be detected between local gesture data and remote gesture data (e.g., received via wireless transmission), wherein the correlation triggers the addition of a third indicator 38 (e.g., “Mega Fan Badge” graphical token/icon) to the UI 32. The third indicator 38 might also be added in response to detection of the attachment of an interchangeable component to the wearable device or the detection of a nearby friend.

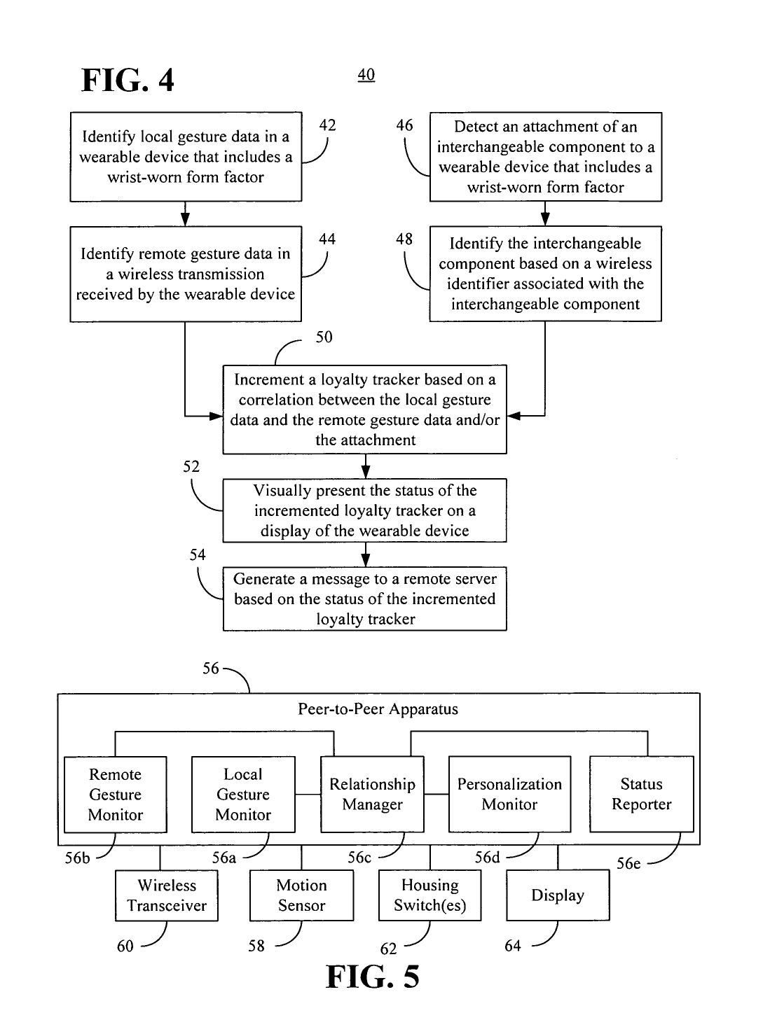

FIG. 4 shows a method 40 of operating a peer-to-peer apparatus. The method 40 may generally be implemented in a wearable device such as, for example, one or more of the friendship bands 12, 14, 16 (FIG. 1) and/or the friendship band 20 (FIG. 2), already discussed. More particularly, the method 40 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 42 provides for identifying local gesture data (e.g., based on one or more signals from a motion sensor) in a wearable device including a wrist-worn form factor, wherein remote gesture data may be identified in a wireless transmission received by the wearable device at block 44. The wireless transmission may be received via peer-to-peer connection such as, for example, a Bluetooth LE (Bluetooth Low Energy, e.g., Bluetooth Core Specification Version 4.0, Jun. 30, 2010, Bluetooth Special Interest Group/SIG), Wi-Fi (Wireless Fidelity, e.g., Institute of Electrical and Electronics Engineers/IEEE 802.11-2007, Wireless Local Area Network/LAN Medium Access Control (MAC) and Physical Layer (PHY) Specifications), or other suitable connection. Indeed, groups of wearable devices may be used to form a mesh network in such a fashion (e.g., without involving hubs, routers, etc.).

Block 46 may also detect an attachment of an interchangeable component (e.g., bead) to the wearable device. Block 46 may include monitoring one or more mechanical switches that are coupled to attachment surfaces, indentations and/or protrusions on an external housing of the wearable device. If the attachment is detected, the interchangeable component may be identified at block 48 based on a wireless identifier (e.g., embedded near field communications/NFC or radio frequency identifier/RFID tag) associated with the interchangeable component.

Illustrated block 50 increments a loyalty tracker based on a correlation between the local gesture data and the remote gesture data and/or the detected attachment. Block 50 may therefore include comparing the local gesture data with the remote gesture data to determine, for example, whether two hand motions are substantially similar and/or follow a predetermined sequence. The comparison may involve extracting features, determining confidence levels, and so forth. Block 50 may also include determining the amount of the increment based on the nature of the hand gesture data and/or the type of interchangeable component detected. The status of the incremented loyalty tracker may be presented on a display of the wearable device at block 52. Additionally, block 54 may generate a message to a remote server such as, for example, a fan page, social networking site or brand analytics site, based on the status of the incremented loyalty tracker. The message may be statistical in nature (e.g., protecting the anonymity of the wearer of the device) or associated with a user account (e.g., part of a brand loyalty program).

Turning now to FIG. 5, a peer-to-peer apparatus 56 (56a-56e) is shown. The apparatus 56, which may include logic instructions, configurable logic, fixed-functionality logic hardware, etc., or any combination thereof, may generally implement one or more aspects of the method 40 (FIG. 4), already discussed. Accordingly, the apparatus 56 may be implemented in a wearable device such as, for example, one or more of the friendship bands 12, 14, 16 (FIG. 1) and/or the friendship band 20 (FIG. 2). In the illustrated example, a local gesture monitor 56a identifies local gesture data in a wearable device. The local gesture data may be obtained from a motion sensor 58 and the wearable device may have a wrist-worn form factor. The wearable device might also be in the shape of a ring or other hand-mounted physical configuration. Additionally, a remote gesture monitor 56b may identify remote gesture data in a wireless transmission received by the wearable device. In one example, a wireless transceiver 60 (e.g., Bluetooth LE, Wi-Fi radio) receives the wireless transmission via a peer-to-peer connection (e.g., mesh network).

The illustrated apparatus 56 also includes a relationship manager 56c communicatively coupled to the local gesture monitor 56a and the remote gesture monitor 56b. The relationship manager 56c may increment or otherwise adjust a loyalty tracker (e.g., a counter) based on a correlation between the local gesture data and the remote gesture data. The correlation may include a substantially similar and/or a predetermined sequence of hand motions on the part of a user of the wearable device and another user of a remote wearable device.

A personalization monitor 56d may also be communicatively coupled to the relationship manager 56c, wherein the personalization monitor 56d is configured to detect, via one or more housing switches 62, an attachment of one more interchangeable components (not shown) to the wearable device. In such a case, the relationship manager 56c may increment the loyalty tracker further in response to the attachment. In one example, the personalization monitor 56d identifies the one or more interchangeable components based on wireless identifiers associated with the interchangeable component(s). The connections between the apparatus 56 and the wireless transceiver 60, the motion sensor 58, the housing switches 62 and the display 64 may be over a bus, switching fabric or other suitable interface. The illustrated apparatus 56 also includes a status reporter 56e to visually present the status of the incremented loyalty tracker on a display 64 of the wearable device. The status reporter 56e may also generate one or more messages to a remote server (not shown) based on the status of the incremented loyalty tracker.

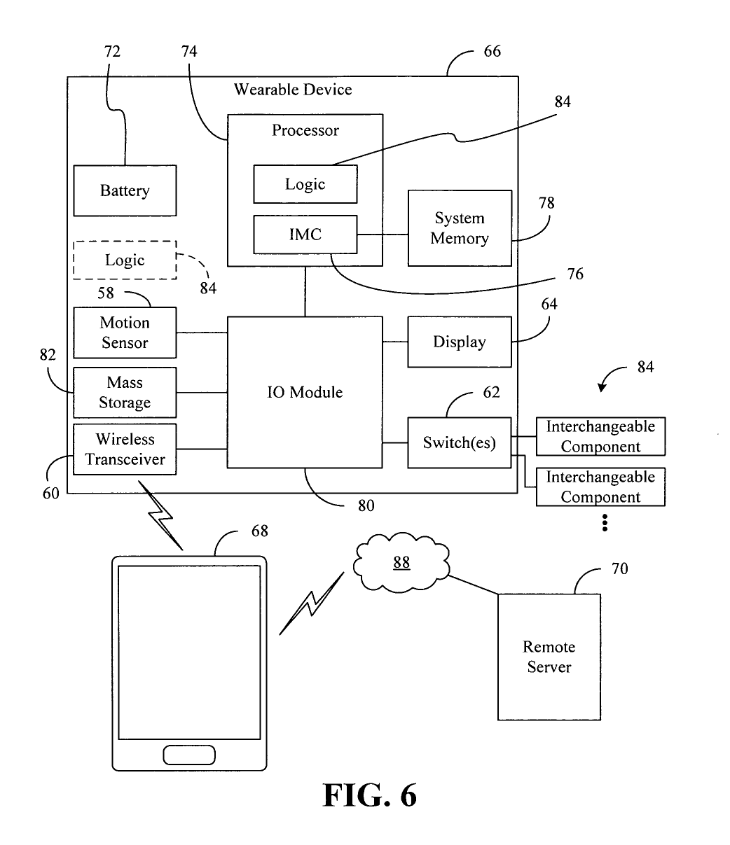

FIG. 6 shows a relationship facilitation architecture that includes a wearable device 66, a handheld device 68 and a remote server 70. In the illustrated example, the wearable device 66 includes a battery 72 to supply power to the wearable device 66 and a processor 74 having an integrated memory controller (IMC) 76, which may communicate with system memory 78. The system memory 78 may include, for example, dynamic random access memory (DRAM) configured as one or more memory modules such as, for example, dual inline memory modules (DIMMs), small outline DIMMs (SODIMMs), etc.

The illustrated wearable device 66 also includes an input output (IO) module 80 implemented together with the processor 74 on a semiconductor die (not shown) as a system on chip (SoC), wherein the JO module 80 functions as a host device and may communicate with, for example, the display 64 (e.g., touch screen, liquid crystal display/LCD, light emitting diode/LED display), the motion sensor 58 (e.g., accelerometer, gyroscope), the wireless transceiver 60, and mass storage 82 (e.g., flash memory, block storage, solid state disk/SSD, etc.). The processor 74 may include logic 84 (e.g., implemented in logic instructions, configurable logic, fixed-functionality logic hardware, etc., or any combination thereof) that identifies local gesture data based on one or more signals from the motion sensor 58 and identifies remote gesture data in a wireless transmission received, over a peer-to-peer connection, by the wireless transceiver 60. The logic 84 may also increment a loyalty tracker based on a correlation between the local gesture data and the remote gesture data.

The logic 84 may also detect an attachment of one or more interchangeable components 86 to the wearable device 66 and identify the interchangeable components 86 based on wireless identifiers (e.g., RFID tags) associated with the interchangeable components 86. In such a case, the logic 84 may further increment the loyalty tracker based on the attachment(s). Additionally, the logic 84 may visually present the status of the incremented loyalty tracker on the display 64. Moreover, the logic 84 may generate one or more messages to the remote server 70 based on a status of the incremented loyalty tracker. In one example, the messages are communicated to the handheld device 68 via a peer-to-peer connection, wherein the handheld device 68 may forward the messages to the remote server 70 over a network infrastructure 88. The wireless transceiver 60 may also be used to transmit local gesture data to other wearable devices (not shown).

The handheld device 68 may include one or more applications configured to create and send indicators (e.g. badges) to the wearable device 66 as well as other wearable devices, assist a user of the wearable device 66 in locating nearby friends (e.g., on a map), automatically post loyalty tracker events to social media, and so forth. The handheld device 68 may also share personal information (e.g., phone number, email address, social network handle) corresponding to a user of the wearable device 66 with other wearable devices and/or handheld devices.

### ADDITIONAL NOTES AND EXAMPLES

Example 1 may include a wearable device comprising a battery to supply power to the wearable device, a housing including a wrist-worn form factor, a wireless transceiver to receive a wireless transmission, a motion sensor, a first gesture monitor to identify local gesture data based on one or more signals from the motion sensor, a second gesture monitor to identify remote gesture data in the wireless transmission, and a relationship manager communicatively coupled to the first gesture monitor and the second gesture monitor, the relationship manager to increment a loyalty tracker based on a correlation between the local gesture data and the remote gesture data.

Example 2 may include the wearable device of Example 1, further including a personalization monitor communicatively coupled to the relationship manager, the personalization monitor to detect an attachment of an interchangeable component to the wearable device, wherein the relationship manager is to increment the loyalty tracker in response to the attachment.

Example 3 may include the wearable device of Example 2, wherein the personalization monitor is to identify the interchangeable component based on a wireless identifier associated with the interchangeable component.

Example 4 may include the wearable device of Example 1, further including a display, and a status reporter communicatively coupled to the relationship manager and the display, the status reporter to visually present a status of the incremented loyalty tracker on the display.

Example 5 may include the wearable device of Example 1, further including a status reporter communicatively coupled to the relationship manager, the status reporter to generate a message to a remote server based on a status of the incremented loyalty tracker.

Example 6 may include the wearable device of any one of Examples 1 to 5, wherein the wireless transmission is to be received via a peer-to-peer connection.

Example 7 may include a peer-to-peer apparatus comprising a first gesture monitor to identify local gesture data in a wearable device including a wrist-worn form factor, a second gesture monitor to identify remote gesture data in a wireless transmission received by the wearable device, and a relationship manager communicatively coupled to the first gesture monitor and the second gesture monitor, the relationship manager to increment a loyalty tracker based on a correlation between the local gesture data and the remote gesture data.

Example 8 may include the apparatus of Example 7, further including a personalization monitor communicatively coupled to the relationship manager, the personalization monitor to detect an attachment of an interchangeable component to the wearable device, wherein the relationship manager is to increment the loyalty tracker in response to the attachment.

Example 9 may include the apparatus of Example 8, wherein the personalization monitor is to identify the interchangeable component based on a wireless identifier associated with the interchangeable component.

Example 10 may include the apparatus of Example 7, further including a status reporter communicatively coupled to the relationship manager, the status reporter to visually present a status of the incremented loyalty tracker on a display of the wearable device.

Example 11 may include the apparatus of Example 7, further including a status reporter communicatively coupled to the relationship manager, the status reporter to generate a message to a remote server based on a status of the incremented loyalty tracker.

Example 12 may include the apparatus of any one of Examples 7 to 11, wherein the wireless transmission is to be received via a peer-to-peer connection.

Example 13 may include a method of operating a peer-to-peer apparatus comprising identifying local gesture data in a wearable device including a wrist-worn form factor, identifying remote gesture data in a wireless transmission received by the wearable device, and incrementing a loyalty tracker based on a correlation between the local gesture data and the remote gesture data.

Example 14 may include the method of claim 13, further including detecting an attachment of an interchangeable component to the wearable device, and incrementing the loyalty tracker in response to the attachment.

Example 15 may include the method of claim 14, further including identifying the interchangeable component based on a wireless identifier associated with the interchangeable component.

Example 16 may include the method of claim 13, further including visually presenting a status of the incremented loyalty tracker on a display of the wearable device.

Example 17 may include the method of claim 13, further including generating a message to a remote server based on a status of the incremented loyalty tracker.

Example 18 may include the method of any one of claims 13 to 17, wherein the wireless transmission is received via a peer-to-peer connection.

Example 19 may include at least one non-transitory computer readable storage medium comprising a set of instructions, which when executed by a wearable device including a wrist-worn form factor, cause the wearable device to identify local gesture data in the wearable device, identify remote gesture data in a wireless transmission received by the wearable device, and increment a loyalty tracker based on a correlation between the local gesture data and the remote gesture data.

Example 20 may include the at least one non-transitory computer readable storage medium of claim 19, wherein the instructions, when executed, cause the wearable device to detect an attachment of an interchangeable component to the wearable device, and increment the loyalty tracker in response to the attachment.

Example 21 may include the at least one non-transitory computer readable storage medium of claim 20, wherein the instructions, when executed, cause the wearable device to identify the interchangeable component based on a wireless identifier associated with the interchangeable component.

Example 22 may include the at least one non-transitory computer readable storage medium of claim 19, wherein the instructions, when executed, cause the wearable device to visually present a status of the incremented loyalty tracker on a display of the wearable device.

Example 23 may include the at least one non-transitory computer readable storage medium of claim 19, wherein the instructions, when executed, cause the wearable device to generate a message to a remote server based on a status of the incremented loyalty tracker.

Example 24 may include the at least one non-transitory computer readable storage medium of any one of claims 19 to 23, wherein the wireless transmission is to be received via a peer-to-peer connection.

Example 25 may include a peer-to-peer apparatus comprising means for identifying local gesture data in a wearable device including a wrist-worn form factor, means for identifying remote gesture data in a wireless transmission received by the wearable device, and means for incrementing a loyalty tracker based on a correlation between the local gesture data and the remote gesture data.

Example 26 may include the apparatus of claim 25, further including means for detecting an attachment of an interchangeable component to the wearable device, and means for incrementing the loyalty tracker in response to the attachment.

Example 27 may include the apparatus of claim 26, further including means for identifying the interchangeable component based on a wireless identifier associated with the interchangeable component.

Example 28 may include the apparatus of claim 25, further including means for visually presenting a status of the incremented loyalty tracker on a display of the wearable device.

Example 29 may include the apparatus of claim 25, further including means for generating a message to a remote server based on a status of the incremented loyalty tracker.

Example 30 may include the apparatus of any one of claims 25 to 29, wherein the wireless transmission is to be received via a peer-to-peer connection.

Techniques described herein may therefore use wearable technology to facilitate interpersonal connections between individuals, followers of brands, supporters of causes, and so forth. Techniques may also encourage individuals to continue using wearable devices in order to strengthen social connections. Moreover, the wearable devices may evolve with the individual through multiple usages and customizable physical assets (e.g., interchangeable components).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A wearable device comprising:
a battery to supply power to the wearable device;
a housing including a wrist-worn form factor;
a wireless transceiver to receive a wireless transmission;
a motion sensor;
a first gesture monitor to identify local gesture data based on one or more signals from the motion sensor;
a second gesture monitor to identify remote gesture data in the wireless transmission; and
a relationship manager communicatively coupled to the first gesture monitor and the second gesture monitor, the relationship manager to increment a loyalty tracker based on a correlation between the local gesture data and the remote gesture data.

2. The wearable device of claim 1, further including a personalization monitor communicatively coupled to the relationship manager, the personalization monitor to detect an attachment of an interchangeable component to the wearable device, wherein the relationship manager is to increment the loyalty tracker in response to the attachment.

3. The wearable device of claim 2, wherein the personalization monitor is to identify the interchangeable component based on a wireless identifier associated with the interchangeable component.

4. The wearable device of claim 1, further including:
a display; and
a status reporter communicatively coupled to the relationship manager and the display, the status reporter to visually present a status of the incremented loyalty tracker on the display.

5. The wearable device of claim 1, further including a status reporter communicatively coupled to the relationship manager, the status reporter to generate a message to a remote server based on a status of the incremented loyalty tracker.

6. The wearable device of claim 1, wherein the wireless transmission is to be received via a peer-to-peer connection.

7. An apparatus comprising:
a first gesture monitor to identify local gesture data in a wearable device including a wrist-worn form factor;
a second gesture monitor to identify remote gesture data in a wireless transmission received by the wearable device; and
a relationship manager communicatively coupled to the first gesture monitor and the second gesture monitor, the relationship manager to increment a loyalty tracker based on a correlation between the local gesture data and the remote gesture data.

8. The apparatus of claim 7, further including a personalization monitor communicatively coupled to the relationship manager, the personalization monitor to detect an attachment of an interchangeable component to the wearable device, wherein the relationship manager is to increment the loyalty tracker in response to the attachment.

9. The apparatus of claim 8, wherein the personalization monitor is to identify the interchangeable component based on a wireless identifier associated with the interchangeable component.

10. The apparatus of claim 7, further including a status reporter communicatively coupled to the relationship manager, the status reporter to visually present a status of the incremented loyalty tracker on a display of the wearable device.

11. The apparatus of claim 7, further including a status reporter communicatively coupled to the relationship manager, the status reporter to generate a message to a remote server based on a status of the incremented loyalty tracker.

12. The apparatus of claim 7, wherein the wireless transmission is to be received via a peer-to-peer connection.

13. A method comprising:
identifying local gesture data in a wearable device including a wrist-worn form factor;
identifying remote gesture data in a wireless transmission received by the wearable device; and
incrementing a loyalty tracker based on a correlation between the local gesture data and the remote gesture data.

14. The method of claim 13, further including:
detecting an attachment of an interchangeable component to the wearable device; and
incrementing the loyalty tracker in response to the attachment.

15. The method of claim 14, further including identifying the interchangeable component based on a wireless identifier associated with the interchangeable component.

16. The method of claim 13, further including visually presenting a status of the incremented loyalty tracker on a display of the wearable device.

17. The method of claim 13, further including generating a message to a remote server based on a status of the incremented loyalty tracker.

18. The method of claim 13, wherein the wireless transmission is received via a peer-to-peer connection.

19. At least one non-transitory computer readable storage medium comprising a set of instructions, which when executed by a wearable device including a wrist-worn form factor, cause the wearable device to:
identify local gesture data in the wearable device;
identify remote gesture data in a wireless transmission received by the wearable device; and
increment a loyalty tracker based on a correlation between the local gesture data and the remote gesture data.

20. The at least one non-transitory computer readable storage medium of claim 19, wherein the instructions, when executed, cause the wearable device to:
detect an attachment of an interchangeable component to the wearable device; and
increment the loyalty tracker in response to the attachment.

21. The at least one non-transitory computer readable storage medium of claim 20, wherein the instructions, when executed, cause the wearable device to identify the interchangeable component based on a wireless identifier associated with the interchangeable component.

22. The at least one non-transitory computer readable storage medium of claim 19, wherein the instructions, when executed, cause the wearable device to visually present a status of the incremented loyalty tracker on a display of the wearable device.

23. The at least one non-transitory computer readable storage medium of claim 19, wherein the instructions, when executed, cause the wearable device to generate a message to a remote server based on a status of the incremented loyalty tracker.

24. The at least one non-transitory computer readable storage medium of claim 19, wherein the wireless transmission is to be received via a peer-to-peer connection.
